(19) United States
(12) Patent Application Publication
(10) Pub. No.: US 2018/0139421 A1
(43) Pub. Date: May 17, 2018

(54) METHODS AND APPARATUS FOR CUSTOM COLOR TRANSITION EFFECTS

(71) Applicant: PHILIPS LIGHTING HOLDING B.V., EINDHOVEN (NL)

(72) Inventors: JIN YU, LEXINGTON, MA (US); MAXIMILLAN BEN SHAFFER, ARLINGTON, MA (US)

(73) Assignee: PHILIPS LIGHTING HOLDING B.V.

(21) Appl. No.: 15/566,823

(22) PCT Filed: Apr. 8, 2016
(86) PCT No.: PCT/EP2016/057817

§ 371 Date: Oct. 16, 2017

Related U.S. Application Data
(60) Provisional application No. 62/147,618, filed on Apr. 15, 2015.

(51) Int. Cl. H04N 9/31; H04N 9/64

(52) U.S. Cl. CPC H04N 9/3155; H04N 9/3164; G03B 21/206; H04N 9/643; H04N 9/3182

(57) ABSTRACT

Methods, systems, devices and apparatus for implementing a custom color transition effect on at least one light-emitting fixture device are disclosed. In accordance with exemplary embodiments, a color step for implementing the color transition effect is computed (304) based on a frame rate of the light-emitting fixture device(s) so that pixels are updated on each frame according to the frame rate of the device(s). Computing and employing a color step in this way can be effective in lessening or eliminating perceptible discontinuities between pixels during a display of the color transition effect.

### TECHNICAL FIELD

The present invention is directed generally to light-emitting fixture devices. More particularly, various inventive methods and apparatus disclosed herein relate to the display of color effects on light-emitting fixture devices.

### BACKGROUND

Digital lighting technologies, i.e. illumination based on semiconductor light sources, such as light-emitting diodes (LEDs), offer a viable alternative to traditional fluorescent, HID, and incandescent lamps. Functional advantages and benefits of LEDs include high energy conversion and optical efficiency, durability, lower operating costs, and many others. Recent advances in LED technology have provided efficient and robust full-spectrum lighting sources that enable a variety of lighting effects in many applications. Some of the fixtures embodying these sources feature a lighting module, including one or more LEDs capable of producing different colors, e.g. red, green, and blue, as well as a processor for independently controlling the output of the LEDs in order to generate a variety of colors and color-changing lighting effects, for example, as discussed in detail in U.S. Pat. Nos. 6,016,038 and 6,211,626, incorporated herein by reference.

Light-emitting fixtures utilize LEDs as light sources to present an extensive array of different visual effects. Such visual effects include the display of color effects that provide an aesthetic appeal for various applications, including stage lighting, general illumination as well as decorative lighting devices. Light-emitting fixtures for any of these applications can be configured into a wide variety of shapes and can include customized surfaces with a range of different curvatures to achieve a desired decorative effect.

### SUMMARY

The present disclosure is directed to inventive methods and apparatus for providing improved color transitions of a display of a custom color transition effect in light-emitting fixtures. A color transition effect is a color effect which provides the impression that colors follow each other as they move through a display provided by one or more light-emitting fixtures. When a plurality of fixtures are used, the fixtures display the color transition effect cohesively such that the colors appear to move across the fixtures, where each fixture displays a portion of the effect at any moment. In addition, a set of pixels forming the transition effect can be provided by one or more fixtures. Each pixel is a unit of the display for which the color can be tuned to essentially any desirable color of a color range provided by the corresponding fixture, and can be the smallest color controllable unit of its corresponding fixture or a set of smallest color controllable units. Further, each pixel displays a given color of the transition effect at a given time. Spatial transitioning can be employed to transition colors between pixels of the display. However, when the period or duration of the color transition effect is relatively long, spatial transitioning can result in a perceptible discontinuity between pixels during a color transition. For high quality applications, including, for example, theater and stage lighting applications, a perceptible discontinuity is undesirable, as it diminishes the aesthetic appeal of the effect.

To lessen or eliminate this perceptible discontinuity, exemplary aspects of the present invention configure the fixture device or devices to update the color of pixels for the color transition effect on each frame according to a frame rate of the device(s). The perceptible discontinuity resulting from the use of spatial transitioning alone is due to the fact that, when the duration of the color effect is relatively long, the pixels are not updated on every frame. Thus, by ensuring that the fixture device or devices update the pixels on every frame according to the frame rate of the device(s), embodiments can reduce or remove any perceptible discontinuities between pixels.

Generally, in one aspect, methods, systems and apparatus are directed to implementing a custom color transition effect on at least one light-emitting fixture device including a set of pixels. Here, at least one color transition effect parameter for the set of pixels is received. In addition, based on the color transition effect parameter(s) and on a frame rate of the fixture device(s), a color step is computed such that each pixel of the set of pixels for the color transition effect is updated on each frame according to the frame rate of the device(s). Further, the custom color transition effect is displayed on the light-emitting fixture devices in accordance with the color step and with the color transition effect parameter(s).

In accordance with exemplary embodiments, the color transition effect parameter(s) includes one or more of a spatial width, a period, a number of color regions, or values of transition color points. Here, the spatial width denotes a total number of pixels of the set of pixels that display colors between consecutive transition color points. In addition, the period denotes a time at which each pixel of the set of pixels completes a color sequence. Any of these color transition effect parameters permit a user to customize the effects displayed by the device(s). In addition, using any one or more of these parameters, the color step can be determined and applied so that the color transition effect is accurately displayed according to a user's specifications, while at the same time ensuring a smooth color transition between pixels.

In one exemplary embodiment, the color step is computed based on a period denoting a time at which each pixel of the set of pixels completes a color sequence. Employing the period in this way enables the embodiment to incorporate a time domain parameter to compute the color step, thereby ensuring that the color step updates pixels on each frame of the device frame rate in a manner that accurately implements the desired color transition effect.

In one version of the embodiment, the color step is computed based on a time width denoting a total number of frames between pixel updates according to a spatial transitioning method that computes corresponding color steps based on a spatial width denoting a total number of pixels of the set that display colors between consecutive transition color points. Utilizing this time width is a convenient means for retrofitting the embodiment to methods and systems that utilize only spatial transitioning to perform color transitions. Thus, employing this time width to determine the color step permits the embodiment to seamlessly display a custom color transition effect in accordance with pre-defined color transition parameter settings with a smoother color transition. Similarly, one or more versions of the embodiment can compute the color step based on a length of a color region delineated by the consecutive transition color points. Use of the color region(s) incorporates spatial transitioning into the color transition, which also permits a convenient means to retrofit the embodiment to methods and systems that utilize spatial transitioning to perform color transitions. Computing and applying the color step based on the time width and/or the color region parameters permit a user to display and view a familiar custom color transition effect with improved color transitions.

In accordance with an embodiment, the frame rate is a maximum frame rate of the device(s). Here, the maximum frame rate is employed to minimize any perceptible discontinuities between pixels during a color transition of the effect.

As used herein for purposes of the present disclosure, the term “color sequence” should be understood to mean the sequence of unique colors a pixel displays through a period, which can be a color transition effect parameter that is set by a user. The period is the time used by a system, method or apparatus to complete the sequence of unique colors. The sequence can be displayed repeatedly at the rate of once per the period.

In addition, the term “transition color point” should be understood to mean a hue at which a color region is delineated. The hue can correspond to a hue that a method, system or apparatus changes the way by which it controls the color of a pixel. For example, as discussed further herein below with respect to the color map depicted in FIG. 1, the hue at which the method, system or apparatus changes the light source used to adjust the color of the pixel is an example of a transition color point. Alternatively, the transition color point can be a hue at which the width of the color step applied to the pixel is changed.

Moreover, the term “color step” should be understood to mean the degree of hue change applied to the color displayed by a pixel at an update of the pixel. As noted above, a “pixel” is a color controllable unit that displays a given color of the color transition effect at a given moment. Additionally, the “frame rate” of a light-emitting fixture device should be understood to mean a frame rate associated with the fixture device that is distinguished from any frame rate and/or properties of the visual effect and/or images displayed by the device. For example, the frame rate can be the maximum frame rate that the light-emitting fixture device is capable of displaying a visual effect and/or images. Alternatively, the frame rate can be a pre-defined frame rate to which the light-emitting fixture device is set independently of the visual effect and/or images displayed by the device.

Further, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED may include a number of dies which respectively emit different spectra of electroluminescence that, in combination, mix to form a desired color, such as, for example, white light. In another implementation, an LED may employ a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “spectrum” should be understood to refer to any one or more frequencies (or wavelengths) of radiation produced by one or more light sources. Accordingly, the term “spectrum” refers to frequencies (or wavelengths) not only in the visible range, but also frequencies (or wavelengths) in the infrared, ultraviolet, and other areas of the overall electromagnetic spectrum. Also, a given spectrum may have a relatively narrow bandwidth (e.g., a FWHM having essentially few frequency or wavelength components) or a relatively wide bandwidth (several frequency or wavelength components having various relative strengths). It should also be appreciated that a given spectrum may be the result of a mixing of two or more other spectra (e.g., mixing radiation respectively emitted from multiple light sources).

For purposes of this disclosure, the term “color” is used interchangeably with the term “spectrum.” However, the term “color” generally is used to refer primarily to a property of radiation that is perceivable by an observer (although this usage is not intended to limit the scope of this term). Accordingly, the terms “different colors” implicitly refer to multiple spectra having different wavelength components and/or bandwidths. It also should be appreciated that the term “color” may be used in connection with both white and non-white light.

The terms “lighting fixture” and “light-emitting fixture” are used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more computer-readable storage mediums (generically referred to herein as “memory,” e.g., volatile and non-volatile computer memory such as RAM, PROM, EPROM, and EEPROM, floppy disks, compact disks, optical disks, magnetic tape, etc.). In some implementations, the storage mediums may be encoded with one or more programs that, when executed on one or more processors and/or controllers, perform at least some of the functions discussed herein. Various storage mediums may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers. In some implementations, computer readable signal mediums may be encoded with one or more programs that, when executed on one or more processors and/or controllers, perform at least some of the functions discussed herein. For example, a signal medium can be an electromagnetic medium, such as a radio frequency medium, and/or an optical medium, through which a data signal is propagated.

The term “addressable” is used herein to refer to a device (e.g., a light source in general, a lighting unit or fixture, a controller or processor associated with one or more light sources or lighting units, other non-lighting related devices, etc.) that is configured to receive information (e.g., data) intended for multiple devices, including itself, and to selectively respond to particular information intended for it. The term “addressable” often is used in connection with a networked environment (or a “network,” discussed further below), in which multiple devices are coupled together via some communications medium or media.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g. for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

The term “user interface” as used herein refers to an interface between a human user or operator and one or more devices that enables communication between the user and the device(s). Examples of user interfaces that may be employed in various implementations of the present disclosure include, but are not limited to, switches, potentiometers, buttons, dials, sliders, a mouse, keyboard, keypad, various types of game controllers (e.g., joysticks), track balls, display screens, various types of graphical user interfaces (GUIs), touch screens, microphones and other types of sensors that may receive some form of human-generated stimulus and generate a signal in response thereto.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a high-level diagram including a color map and a pixel axis illustrative of a custom color transition effect in accordance with exemplary embodiments.

FIG. 2 is a high-level diagram including color maps and pixel axes illustrating a comparison between frames of a color transition effect that employs only spatial transitioning and frames of a custom color transition effect in accordance with exemplary embodiments.

FIG. 3 is a high-level block/flow diagram of a system for implementing a custom color transition effect on one or more a light-emitting fixture devices in accordance with exemplary embodiments.

FIG. 4 is a high-level block/flow diagram of a method for implementing a custom color transition effect on one or more light-emitting fixture device(s) in accordance with exemplary embodiments.

### DETAILED DESCRIPTION

Color transition effects displayed by lighting fixtures can include perceptible discontinuities between pixels under certain circumstances. For example, if only spatial transitioning is employed to configure the color sequence of the effect and the period of the effect is relatively long, then the device may display a given color at a pixel for several frames before updating the color to implement the effect. As a result, discontinuities can appear between pixels.

The applicants have recognized and appreciated that a perceptible discontinuity can be lessened or eliminated by ensuring that the pixels are updated on every frame of the frame rate of the fixture device(s) when implementing a color transition effect. In view of the foregoing, various embodiments and implementations of the present invention are directed to methods, systems and apparatus that compute a color step based on the frame rate of a light-emitting fixture device(s) such that each pixel of the color transition effect is updated on each frame according to a frame rate of the device(s). Thus, in accordance with exemplary aspects, time is another dimension that can be employed to apply color transitioning.

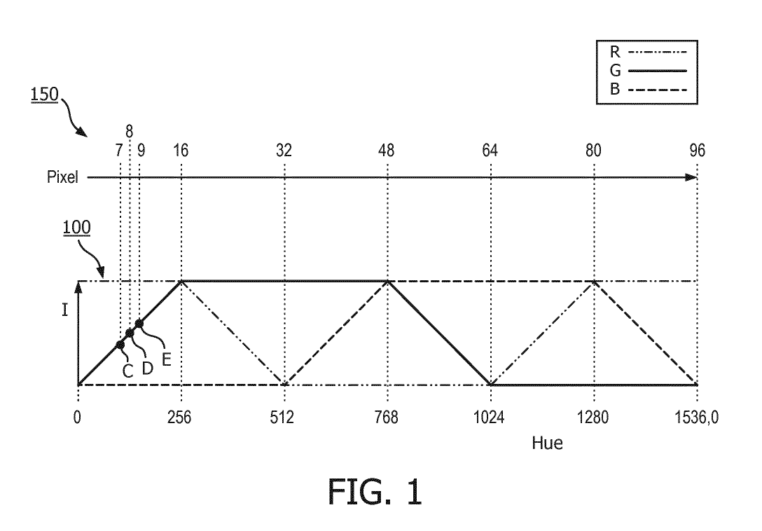

Referring to FIG. 1, a color map 100 and a pixel axis 150 is depicted to illustrate a snapshot of an example of a custom color transition effect. The effect illustrated in FIG. 1 is a custom rainbow effect. However, it should be understood that embodiments of the present application are not limited to rainbow effects and can include any colors and transitions between any color. The horizontal axis of the color map 100 indicates hue (H) values while the vertical axis of the color map indicates the intensity (I) values of color components of a pixel. The color map 100 includes six colors delineated by six transition color points, {0, 256, 512, 768, 1024, 1280}, with six basic color regions: 0-256, 256-512, 512-768, 768-1024, 1024-1280 and 1280 to 1536 or 0. The transition color points 1536 and 0 in the color map refer to the same hue value. It should be understood that the use of six colors and six transition color points is merely exemplary and that other numbers of colors and transition color points can be used. Here, each individual hue value is a particular composite of color component intensities. Red (R), green (G) and blue (B) component intensities are denoted by the R, G and B curves in the map 100. Further, in this basic example, a color region is delineated by the particular primary and secondary color components which define the hue values. For example, red is the primary color component and green is the secondary color component in the region 0-256, green is the primary color component and red is the secondary color component in region 256-512, green is the primary color component and blue is the secondary color component in the region 512-768, blue is the primary color component and green is the secondary color component in the region 768-1024, blue is the primary color component and red is the secondary color component in the region 1024-1280, and red is the primary color component and blue is the secondary color component in the region 1280 to 1536 or 0. Although the color regions {0-256, 256-512, 512-768, 768-1024, 1024-1280, 1280-1536, 0} correspond to the primary/secondary color components in this example for ease of explanation, as discussed further herein below, user-defined color regions can be employed to further customize the color transition effect.

In exemplary embodiments that employ the color map 100, the hue of each basic color region between transition color points is controlled by varying the intensity of one of three color components: red (R), green (G) and blue (B). For example, in the region delineated by 0-256, the hue is adjusted by varying the intensity of the green component, while maintaining the red component at the highest intensity and the blue component at the lowest intensity. The other basic color regions are similarly controlled. Thus, each pixel can be configured to have a red component, a green component and a blue component, where a red light source can provide the red component, a green light source can provide the green component and a blue light source can provide the blue color component. Accordingly, to control the color of the pixels, the color component intensities can be set to the appropriate hue value as indicated in the color map 100. If a pixel is varied through a color sequence denoted by the map 100, when the pixel transitions from basic color region 0-256 to region 256-512, at transition color point 256, the system/apparatus can be configured to change the light source used to adjust the color of the pixel from the green light source to the red light source. It should be understood that embodiments of the present application is not limited to this configuration. For example, the color map and the pixels can be configured to have four or more different color components, and also corresponding light source(s).

The pixel axis 150 denotes the pixels within a set of pixels used to implement the color transition effect. The pixels illustrated on axis 150 can be pixels from a single light-emitting fixture device or a plurality of light-emitting fixture device nodes, which can be spaced and positioned to achieve a desirable decorative effect. In this particular example, the spatial relationship between the pixels is represented by their positions on the axis. For example, the closest pixel to the right of pixel 8 is pixel 9, the closest pixel to the left of pixel 8 is pixel 7, the closest pixel to the left of pixel 7 is pixel 6, etc. Thus, if, for example, four lighting fixtures were employed, then pixels 1-24 can be provided by a first fixture device, pixels 25-48 can be provided by a second fixture device, pixels 49-72 can be provided by a third fixture device and pixels 73-96 can be provided by a fourth fixture device, where the first to fourth fixtures are positioned generally from left to right. However, it should be understood that the fixtures can be positioned differently with respect to each other. Further, although the set of pixels referenced with respect to FIG. 1 is depicted as a baseline of horizontal pixels, it should be understood that each pixel in the baseline can be representative of a vertical band line of pixels of any length that are updated in the same way as the representative pixel. In addition, the representative baseline of pixels, or set of pixels referenced above, as well as the corresponding band lines of pixels, can be oriented vertically, diagonally, or in any direction. Moreover, although the color sequence moves from left to right on the color map 100 in the example described herein below, the color sequence can move from right to left, or in accordance with a combination of the directionally different color sequences.

In the example illustrated in FIG. 1, the spatial width is 16 pixels and the number of color regions is six. The spatial width is a parameter in the spatial domain and denotes a total number of pixels of the set that display colors between consecutive transition color points, which can delineate a color region and can be user-defined. In other words, any given color region is displayed by 16 pixels in this example. Here, there are a total number of 6 color regions×16 pixels/region=96 pixels used in one color space cycle, which is the color sequence of the color transition effect that is displayed in one cycle of the effect. Thus, the number of pixels in the set of pixels of FIG. 1 is 96 pixels. As discussed further herein below, the spatial width and/or the set of pixels can be defined by a user to customize the color transition effect.

As shown in FIG. 1, the pixel positions and the corresponding hue values illustrate a snapshot of the color transition effect. For example, pixels 16, 32, 48, etc. have hue values of 256, 512, 768, etc., respectively. The hue values of the color map 100 in this example are equally divided among the total number, 96, pixels.

In accordance with one space transitioning method, on each pixel update, any given pixel displays the previous hue value of the preceding pixel. For example, assume that the custom color transition effect is displayed as shown in the snapshot in FIG. 1, where pixels 7, 8 and 9 respectively have hue values of C, D and E. On the following pixel update (e.g., first update), pixel 8 displays hue value C and pixel 9 displays hue value D. The remaining pixels are updated similarly. In addition, on the next update (e.g., second update), pixel 9 has hue value C, and the other pixels are updated similarly. Thus, in this way, for example, the method, system or apparatus, provides the impression that colors of a color sequence follow each other as they move through the display. The color sequence of 96 hue values are displayed by each pixel through one period or duration and can be repeated by each pixel.

The color step, Δₛ, utilized in this spatial transitioning method can be found in accordance with equation 1 below.

$${Δ}_{s} = \frac{{pixel}_{end} ( i ) - {pixel}_{start} ( i )}{width} , i = 0 , 1 , 2 \qquad ( 1 )$$

Here, “pixelₛₜₐᵣₜ(i)” can denote a color component intensity of a hue value of a transition color point and the “pixel_{end}(i)” can denote the color component intensity of the hue value of the consecutive, next transition color point in the color sequence. In addition, “width” denotes the spatial width, which is 16 pixels in this example. Further, i indicates the color component, where i=0 can correspond to the red component, i=1 can correspond to the green component and i=2 can correspond to the blue component. Thus, for example, for the starting transition color point 0 and the ending transition color point 256, only the green component reflects a change of intensity in the numerator of equation 1, while the red and blue components have a zero change of intensity in the numerator of equation 1.

When the period or duration is relatively long, if only space transitioning is employed, then a perceptible discontinuity between pixels may be observed. In particular, a long duration can cause the display of a color transition effect in which pixels are not updated on every frame. For example, the pixels are updated according the formula

$$number of frames = \frac{frame rate * period}{number of color steps} \qquad ( 2 )$$

If the period or duration is 10 seconds and the frame rate of the light-emitting fixture device is 40 frames per second, then each pixel is updated every 40×10/96=4 frames by the color step Δₛ. As indicated above, with the 96 hue values, 96 color steps are employed when this space transitioning is used. Because each pixel is updated every four frames, a discontinuity between the pixels is readily observable when the pixels run through the color sequence.

As opposed to updating the pixels every four frames in accordance with space transitioning, in accordance with exemplary aspects of the present invention, a smaller color step can be applied to update the pixels on each frame by employing the temporal dimension as a transitioning factor.

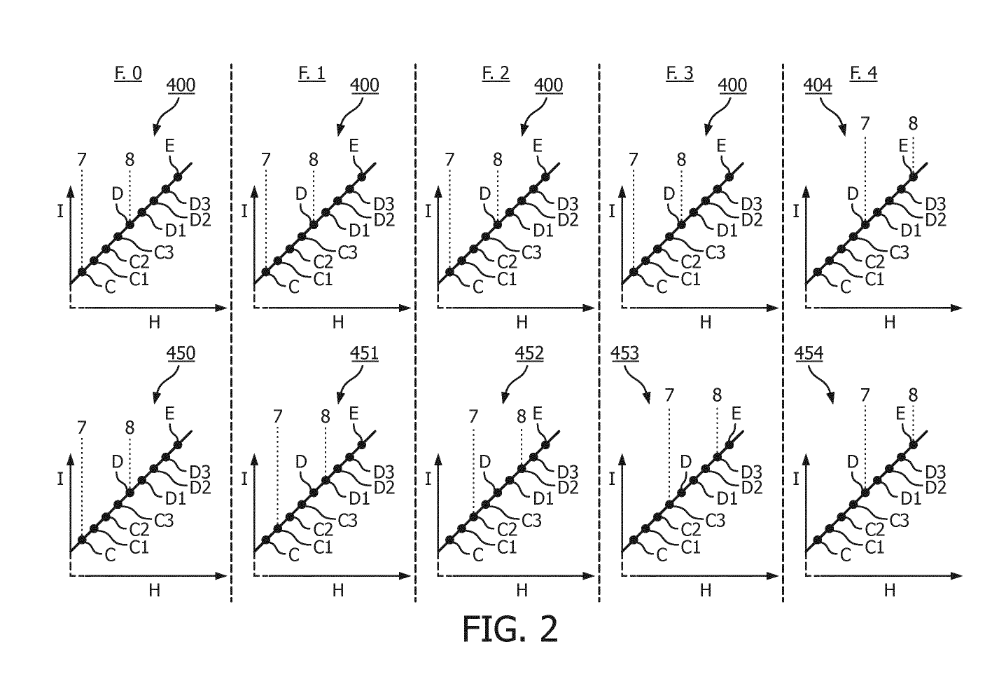

FIG. 2 illustrates a comparison between a color transition effect employing spatial transitioning and a color transition effect employing a spatial-temporal transitioning in accordance with exemplary embodiments. Continuing with the example described above with respect to FIG. 1, four frames, F.0 to F.4, of the color transitioning effect using both transitioning types for this example are illustrated for pixels 7 and 8. Here, a blow-up around color points C, D and E of the color map 100 in FIG. 1 is shown in each of the color maps illustrated in FIG. 2, with “I” denoting intensity and “H” denoting hue. For clarity of illustration, only the green color component is illustrated in FIG. 2, as red and blue components do not change in the time span illustrated in FIG. 2. Color points C, D and E in FIG. 2 are the same as in FIG. 1, and color points C1-C3 correspond to hue values between points C and D, while color points D1-D3 correspond to hue values between color points D and E. The difference between consecutive hue values denoted in FIG. 2 can correspond to the color step Δ_{sT}, which is described in detail herein below.

In FIG. 2, the top row of pixel display configurations 400-404 corresponds to a display of a color transition effect in accordance with a spatial transitioning scheme, and the bottom row of pixel display configurations 450-454 correspond to a display of a color transition effect in accordance with a spatial-temporal transitioning scheme. In frame F.0, pixels 7 and 8 in the pixel display configuration 450 of the spatial-temporal transitioning scheme display the same colors as the pixel display configuration 400 of the spatial transitioning scheme; namely pixel 7 displays color point C and pixel 8 displays color point D. As illustrated in the top row of FIG. 1, the spatial transitioning scheme displays the same configuration 400 through frames F.1, F.2, and F.3. It is not until frame F.4 that the spatial transitioning scheme updates the pixels so that pixel 7 displays color point D by color step Δₛ and pixel 8 displays color point E by color step Δₛ, where the color step corresponds to the difference between color points C and D, or equivalently, between color points D and E.

In contrast, a spatial-temporal transitioning scheme in accordance with exemplary embodiments updates the pixels using smaller color step Δ_{sT} on each frame of the frame rate of the device(s). For example, in frame F.1, the spatial-temporal transitioning scheme updates pixel 7 by color step Δ_{sT} so that it displays color point C1 and updates pixel 8 by color step Δ_{sT} so that it displays color point D1. Similarly, in frame F.2, the spatial-temporal transitioning scheme updates pixel 7 by color step Δ_{sT} so that it displays color point C2 and updates pixel 8 by color step Δ_{sT} so that it displays color point D2; in frame F. 3, the spatial-temporal transitioning scheme updates pixel 7 by color step Δ_{sT} so that it displays color point C3 and updates pixel 8 by color step Δ_{sT} so that it displays color point D3; and in frame F.4, the spatial-temporal transitioning scheme updates pixel 7 by color step Δ_{sT} so that it displays color point D and updates pixel 8 by color step Δ_{sT} so that it displays color point E. As illustrated in FIG. 2, in frame F.4 of in this example, the pixel display configuration 454 of the spatial-temporal transitioning scheme is the same as the pixel display configuration 404 of the spatial transitioning scheme. However, the spatial-temporal transitioning scheme provides a smoother color transition between points C and D for pixel 7 and points D and E for pixel 8. The remaining pixels are updated in the same manner using the color step Δ_{sT}. Thus, in this way, for example, any perceptible discontinuities between pixels can be lessened or eliminated and the color transitioning of the effect can be improved.

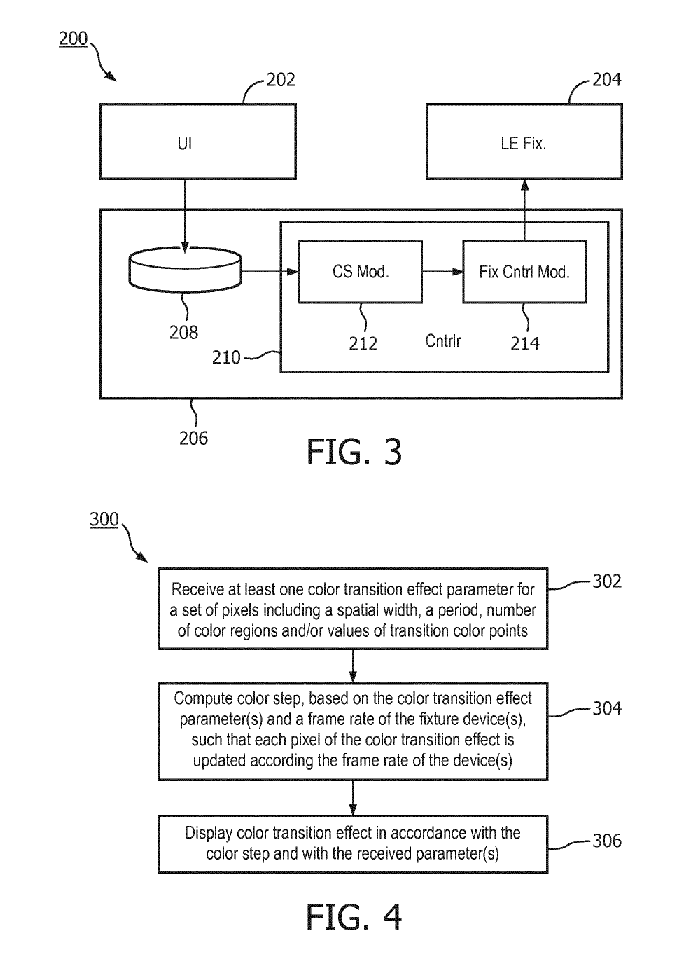

Referring now to FIGS. 3 and 4, a system 200 and a method 300 for implementing a custom color transition effect on at least one light-emitting fixture device in accordance with exemplary embodiments are illustratively depicted. The system 200 includes a user-interface (UI) 202, a computer system 206 and a light-emitting fixture system (LE Fix.) 204. As indicated above, the light-emitting fixture system 204 can be composed of a single light-emitting fixture device or a plurality of light-emitting fixture devices. The computer system 206 includes a storage medium 208 and a controller (Cntrlr) 210, which in turn includes a color step module (CS Mod.) 212 and a fixture control module (Fix. Cntrl Mod.) 214. The storage medium 208 can store a program of instructions implementing the method 300 that can be executed by the controller 210.

The method 300 can begin at step 302, at which at least one color transition effect parameter for a set of pixels can be received. Here, a spatial width, a period, a number of color regions and/or value(s) of the transition color points can be received. For example, a user may specify any one or more of these parameters through the user-interface 202 and the computing system 206 can store the parameters in the storage medium 208 for reference by the controller 210. As discussed above, the spatial width can denote a total number of pixels of the set of pixels that display colors between consecutive transition color points. In the example provided above, the spatial width was 16 pixels; however, the width can be any value selectable by the user. The period, as noted above, can denote a time at which each pixel of the set of pixels completes a color sequence. Further, the values of transition color points can denote the number of color regions used. Thus, by specifying any one or more of these parameters, the user can customize the color transition effect that is displayed on the light-emitting fixture device 204. If any of these parameters are not received from a user, then the parameters can be pre-defined and stored in the storage medium 208 for reference by the controller 210.

Continuing with the example discussed above with respect to FIG. 1, a user can select the spatial width to be 16 pixels and can select the transition color points as follows: {0, 256, 512, 768, 1024, 1280}. Here, the transition color point set provided by the user can define the 6 color regions provided in FIG. 1, where each color region is delineated by the transition color points, as discussed above. In this example, the system 206 can assume that the last color point 1280 and the first color point 0 (or 1536) define a region so that an entire rainbow of colors is displayed. It should be noted that the color points and the color regions can be presented to the user in a convenient and simple manner. For example, colors of a color map can be displayed, permitting the user to select, using a mouse for example, any particular color points to define the color regions.

It should be noted that the user can select a subset of colors for the color transition effect. For example, if a user selects color points {0, 256, 768}, two or three color regions can be defined by the transition color points. In particular, the length of the color region is defined by the transition color points delineating that region. Here, one region is defined by the block 0-256 and another region is defined by the block 256-768. Thus, the system 206 can be configured to direct the light-emitting fixture device(s) 204 to display a subset of rainbow colors that are between 0 and 768. Optionally, the system 206 can define a third color region by the block 768 to 0 or 1536, as discussed above. Here, if the set of transition color points defines two regions and a user selects a spatial width of 16, at any particular snapshot of the effect, 16 pixels will display colors in the region between 0 and 256, and 16 pixels will display colors in the region between 256 and 768 with a wider color spacing. Although in this example the color spacing is different for the different color regions, within any given region, the color spacing can be divided equally between the pixels. Each pixel, for all color regions, will run through the entire color sequence defined by the selected transition color points once per period or duration, which can be defined by a user, as discussed above. It should be noted that, in some embodiments, the transition color points need not correspond to the hue values 0, 256, 512, 768, 1024, 1280, but can be any user-selected hue value. Further, in accordance with exemplary embodiments, the user can set a different spatial width for each color region selected or for different subsets of color regions selected. Thus, here, transition color points can correspond to the hue value at which the width of the color spacing and/or the width of the color step applied to the pixel is changed, as discussed further herein below.

At step 304, the controller 210 can control, based on at least one of the color transition effect parameters and on the frame rate of the fixture device(s), the light-emitting fixture system 204 to update each pixel of the set of pixels for the custom color transition effect according to the frame rate of the device(s). For example, the controller 210 can set an appropriate color step and ensure that the color step is applied to the pixels on each frame. In particular, the color step module 212 of the controller 210 can compute and apply the color step to implement the update of each pixel on each frame of the frame rate of the device. For example, the color step module 212 can compute a space-time color step as follows:

$${Δ}_{sT} = \frac{{pixel}_{end} ( i ) - {pixel}_{start} ( i )}{width ( timewidth + 1 )} = \frac{{Δ}_{s}}{timewidth + 1} , i = 0 , 1 , 2 \qquad ( 3 )$$

Here, the time width denotes a total number of frames between pixel updates according to a spatial transitioning method. For example, the time width can be the number of frames computed in accordance with equation (2). Thus, equation (3) is based on a period of the custom color transition effect and the frame rate of the device. The remaining elements of equation (3) are the same as in equation (1) discussed above. As shown in equation (3), the color step can also be based on the spatial width, denoted as “width” in equation (3). It should be noted that equation (3) can be applied as a convenient means of retrofitting a method, system or apparatus that employs only a spatial transitioning. However, the color step can be computed by the color step module 212 in other ways based on the period and/or the spatial width. For example, as opposed to employing equation (3), the color step module 212 can compute the color step Δ_{sT} as follows:

$${Δ}_{sT} = \frac{( {pixel}_{end} ( i ) - {pixel}_{start} ( i ) )}{width ( ⌊ \frac{frame\_rate * period}{total\_width} ⌋ + 1 )} , i = 0 , 1 , 2 \qquad ( 4 )$$

Here, “total_width” can denote the total number of space widths of all color regions, and, as discussed above, “pixelₛₜₐᵣₜ(i)” can denote color component intensities of a hue value of a transition color point delineating a particular region and the “pixel_{end}(i)” can denote the color component intensities of the hue value of the consecutive, next transition color point in the color sequence delineating the particular region. The “frame_rate” is the frame rate of the light-emitting fixture device(s) and “period” is the time at which each pixel of the set of pixels completes a color sequence. The total_width in the example described above with respect to FIG. 1 is 96 pixels, as the example included a spatial width of 16 pixels for all color regions and a total of 6 color regions. Alternatively, if two regions are selected and the spatial width selected for the first color region is 30 pixels and the spatial width selected for the second color region is 40 pixels, the total_width is 70 pixels. It should be understood that equations (3) and (4) are applied to each color region. Thus, the “width” denotes the spatial width for the particular color region to which equations (3) and (4) are applied. As indicated above, the transition color points denote the length of the color region. Accordingly, if a user selects color regions of different sizes, then the color steps applied in the respective color regions are different. The values of equations (2), (3) and (4) can be computed from the parameter(s) received at step 302 and/or retrieved by the color step module 212 from the storage medium 208.

At step 306, the fixture control module 214 can direct the light-emitting fixture device 204 to display the custom color transition effect in accordance with the color step and with the received color transition effect parameter(s). For example, the fixture control module 214 can receive the space-time color step from the color step module 212 and the color transition effect parameter(s) from the storage medium 208 and can use these elements to implement the custom color transition effect. If equation (3) or (4) is employed to determine a color step(s), the color step(s) is applied to each pixel in the set of pixels on every frame according to the frame rate of the device(s). As noted above, the frame rate of the device(s) can be the maximum frame rate that the light-emitting fixture device(s) is capable of displaying a visual effect and/or a pre-defined frame rate to which the light-emitting fixture device(s) is set independently of the visual effect displayed by the device(s). If a maximum frame rate is employed and a plurality of light-emitting fixtures with different maximum frame rates are used in the system 204 to implement the effect, then the lowest maximum frame rate can be utilized to ensure consistency of the display. Continuing with the example discussed above with respect to FIGS. 1 and 2, as opposed to updating the pixels in the set of pixels every four frames with color step Δₛ, the fixture control module 214 applies the smaller space-time color step(s) Δ_{sT} on or at every frame according to the frame rate of the device(s) 204 to implement the custom color transition effect. In this example, the custom color transition effect displayed on device(s) 204 is the same as the effect described above with respect to FIG. 1 at every fourth frame, but includes a smoother color transition between these frames. Thus, in this way, for example, the color transitioning effect can be improved by lessening or eliminating any perceptible discontinuities between pixels.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. Further, while the light-emitting fixture system 204 can be fixture devices directly looked upon by the user, the light-emitting fixture system(s) 204 can alternatively or additionally be one or more projector devices that projects the color transition effect on one or more surfaces for viewing by a user. The light-emitting fixture system 204 can be embodied as a group of lighting fixture(s), lighting units, LED-based lighting unit(s), multi-channel lighting unit(s), etc., as discussed above.

More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A system for implementing a custom color transition effect on at least one light-emitting fixture device including a set of pixels comprising:
a storage medium on which at least one color transition effect parameter for the set of pixels is stored, the at least one color transition effect parameter being arranged for customizing the custom color transition effect on the at least one light-emitting fixture device; and
a controller configured to
(i) compute a color step, the color step being a degree of hue change applied to a color displayed by a pixel at an update of that pixel, based on the at least one color transition effect parameter and on a frame rate of the at least one light-emitting fixture device, such that each pixel of the set of pixels for the custom color transition effect is updated on each frame according to the frame rate of the at least one light-emitting fixture device; and to
(ii) direct the at least one light-emitting fixture device to display the custom color transition effect by applying said color step;
wherein the frame rate is a maximum frame rate of the device.

2. The system of claim 1, wherein the at least one color transition effect parameter includes at least one of:
a spatial width denoting a total number of pixels of said set that display colors between consecutive transition color points, the transition color point being a hue at which a color region is delineated;
a period denoting a time at which each pixel of the set of pixels completes a color sequence, the color sequence being a sequence of unique colors each pixel displays through a period;
a number of color regions in said color transition effect, or values of the color transition points.

3. The system of claim 1, wherein the color step is computed based on a period denoting a time at which each pixel of the set of pixels completes a color sequence, the color sequence being a sequence of unique colors each pixel displays through a period.

4. The system of claim 3, wherein the color step is computed based on a time width denoting a total number of frames between pixel updates according to a spatial transitioning method that computes corresponding color steps based on a spatial width denoting a total number of pixels of said set that display colors between consecutive transition color points, the transition color point being a hue at which a color region is delineated.

5. The system of claim 4, wherein the color step is computed based on length of a color region delineated by the consecutive transition color points.

6. (canceled)

7. A computer-readable medium comprising a computer-readable program for implementing a custom color transition effect on at least one light-emitting fixture device including a set of pixels, said program, when executed on a computer, causes the computer to perform the steps of:
computing a color step, the color step being a degree of hue change applied to a color displayed by a pixel at an update of that pixel, based on at least one color transition effect parameter received for the set of pixels, the at least one color transition effect parameter being arranged for customizing the custom color transition effect on the at least one light-emitting fixture device, and on a frame rate of the at least one light-emitting fixture device, such that each pixel of the set of pixels for the custom color transition effect is updated on each frame according to the frame rate of the at least one light-emitting fixture device; and
directing the at least one light-emitting fixture device to display the custom color transition effect on the at least one light-emitting fixture device by applying said color step;
wherein the frame rate is a maximum frame rate of the device.

8. A method for implementing a custom color transition effect on at least one light-emitting fixture device including a set of pixels comprising:
receiving at least one color transition effect parameter for the set of pixels, the at least one color transition effect parameter being arranged for customizing the custom color transition effect on the at least one light-emitting fixture device;
computing a color step, the color step being a degree of hue change applied to a color displayed by a pixel at an update of that pixel, based on the at least one color transition effect parameter and on a frame rate of the at least one light-emitting fixture device, such that each pixel of the set of pixels for the custom color transition effect is updated on each frame according to the frame rate of the at least one light-emitting fixture device; and
displaying the custom color transition effect on the at least one light-emitting fixture device by applying said color;
wherein the frame rate is a maximum frame rate of the at least one light-emitting fixture device.

9. The method of claim 8, wherein the at least one color transition effect parameter includes at least one of:
a spatial width denoting a total number of pixels of said set that display colors between consecutive transition color points, the transition color point being a hue at which a color region is delineated;
a period denoting a time at which each pixel of the set of pixels completes a color sequence, the color sequence being a sequence of unique colors each pixel displayed through a period;
a number of color regions in said color transition effect, or values of the transition color points.

10. The method of claim 8, wherein the color step is computed based on a period denoting a time at which each pixel of the set of pixels completes a color sequence, the color sequence being a sequence of unique colors each pixel displays through a period.

11. The method of claim 10, wherein the color step is computed based on a time width denoting a total number of frames between pixel updates according to a spatial transitioning method that computes corresponding color steps based on a spatial width denoting a total number of pixels of said set that display colors between consecutive transition color points, the transition color point being a hue at which a color region is delineated.

12. The method of claim 11, wherein the color step is computed based on a length of a color region delineated by the consecutive transition color points.

13. (canceled)

14. The system according to claim 1, wherein the at least one light-emitting fixture device is at least one projector device for projecting the custom color transition effect onto a surface
